(19) United States
(12) Patent Application Publication
(10) Pub. No.: US 2019/0315163 A1
(43) Pub. Date: Oct. 17, 2019

(54) PNEUMATIC TIRE

(71) Applicant: TOYO TIRE CORPORATION, Itami-shi (JP)

(72) Inventor: Kouichi Takita, Itami-shi (JP)

(73) Assignee: TOYO TIRE CORPORATION, Itami-shi (JP)

(21) Appl. No.: 16/367,666

(22) Filed: Mar. 28, 2019

(30) Foreign Application Priority Data
Apr. 11, 2018 (JP) 2018-075874

(51) Int. Cl. B60C 13/02

(52) U.S. Cl. CPC B60C 13/02; B60C 2200/14

(57) ABSTRACT

A pneumatic tire has a protrusion provided on a buttress portion. The protrusion includes a side wall protruding from a surface of the buttress portion, and a top wall provided at a distal end of the side wall. The top wall is inclined in the tire circumferential direction such that a protrusion height, which is a distance of the protrusion from the surface of the buttress portion, decreases from one side to the other side in the tire circumferential direction.

### CROSS-REFERENCE TO RELATED APPLICATIONS

This application claims priority of Japanese Patent Application No.: 2018-075874 filed on Apr. 11, 2018, the content of which is incorporated herein by reference.

### BACKGROUND OF THE INVENTION

### Technical Field

The present invention relates to a pneumatic tire.

### Related Art

A pneumatic tire which includes protrusions on a buttress portion is known (JP 2013-82262 A and JP 2015-168301 A). Generally, protrusions of this type are provided to improve traction performance during traveling on rough unpaved roads or bad roads such rocky roads.

### SUMMARY

Modes known as external damage or failure caused during traveling on bad roads include a tear of the buttress portion at bases of the protrusions.

There is still room for improvement, however, over protrusions provided in buttress portions of conventional pneumatic tires, including those disclosed in JP 2013-82262 A and JP 2015-168301 A, for increasing external damage resistance of the protrusions while securing traction performance.

An object of the present invention is to improve external damage resistance of protrusions provided in a buttress portion of a pneumatic tire while securing traction performance.

One aspect of the present invention provides a pneumatic tire including a protrusion provided on a buttress portion. The protrusion includes a side wall protruding from a surface of the buttress portion, and a top wall provided at a distal end of the side wall. The top wall is inclined in a tire circumferential direction such that a protrusion height that is a distance of the protrusion from the surface of the buttress portion decreases from one side to the other side in the tire circumferential direction.

The top wall of the protrusion is inclined in the tire circumferential direction such that the protrusion height decreases from one side to the other side in the tire circumferential direction. In the configuration in which the rotation direction of the pneumatic tire is set such that the side having the smaller protrusion height comes to the kicking side, movement of the protrusion at the time of kicking decreases more than a configuration in which the rotation direction of the pneumatic tire is set such that the side having the larger protrusion height comes to the kicking side. As a result, external damage resistance of the protrusion improves.

Each of a pair of portions included in the side wall and facing each other in the tire circumferential direction may have a quadrangular shape.

The quadrangular shape of one of the pair of portions included in the side wall and facing each other in the tire circumferential direction may have a width equal to a width of the quadrangular shape of the other of the portions, and a height smaller than a height of the other of the portions.

The quadrangular shape of one of the pair of portions included in the side wall and facing each other in the tire circumferential direction may be similar to the quadrangular shape of the other of the portions, and have a dimension smaller than a dimension of the quadrangular shape of the other of the portions.

The pair of portions included in the side wall and facing each other in the tire circumferential direction may have different shapes.

Each of an outer end and an inner end of the protrusion in the tire radial direction is disposed at a height not less than 0.1 and not more than 1.0 times a tire height from an innermost end of the pneumatic tire.

The pneumatic tire may include a block that extends from a tread portion to the buttress portion beyond a tread end. The protrusion may be disposed such that an outer end of the protrusion is located adjacent to an inner end of the block in the tire radial direction.

The block may include a first block having an edge that is defined by a portion extending in the tire width direction and a portion extending in the tire radial direction, and that is located at a first position. The block may include a second block having an edge that is defined by a portion extending in the tire width direction and a portion extending in the tire radial direction, and that is located at a second position closer to a center in the tire width direction than the first position is. The first block and the second block may be alternately arranged in the tire circumferential direction.

A step is formed in the tire circumferential direction by the edge of the first block and the edge of the second block. Traction performance further improves by cooperative operation of the first and second blocks forming this step, and the protrusion.

According to the present invention, external damage resistance of a protrusion provided on a buttress portion of a pneumatic tire improves while securing traction performance.

### BRIEF DESCRIPTION OF THE DRAWINGS

The foregoing and the other features of the present invention will become apparent from the following description and drawings of an illustrative embodiment of the invention in which:

FIG. 1 is a meridian cross-sectional view of a pneumatic tire according to a first embodiment of the present invention;

FIG. 2 is a partial developed view of a tread portion and a buttress portion of the pneumatic tire according to the first embodiment of the present invention;

FIG. 3 is a partial side view of the buttress portion according to the first embodiment of the present invention;

FIG. 4A is a perspective view of a protrusion according to the first embodiment of the present invention;

FIG. 4B is a view of the protrusion according to the first embodiment of the present invention as viewed in a tire width direction;

FIG. 4C is a view of the protrusion according to the first embodiment of the present invention as viewed from the outside in a tire radial direction;

FIG. 4D is a view of the protrusion according to the first embodiment of the present invention as viewed from the inside in the tire radial direction;

FIG. 5A is a perspective view of a protrusion according to a second embodiment of the present invention;

FIG. 5B is a view of the protrusion according to the second embodiment of the present invention as viewed in the tire width direction;

FIG. 5C is a view of the protrusion according to the second embodiment of the present invention as viewed from the outside in the tire radial direction;

FIG. 5D is a view of the protrusion according to the second embodiment of the present invention as viewed from the inside in the tire radial direction; and

FIG. 6 is a perspective view of a protrusion according to a third embodiment of the present invention.

### DETAILED DESCRIPTION OF EMBODIMENTS

An embodiment according to the present invention is hereinafter described with reference to the accompanying drawings. It should be noted that the following description is essentially presented by way of example, and not intended to limit the present invention, applicable ranges of the present invention, or purposes of use of the present invention. In addition, the accompanying drawings are only schematic figures, and do not show actual ratios or the like of respective dimensions.

In each of the figures, an X direction corresponds to a tire radial direction, a Y direction corresponds to a tire circumferential direction, and a Z direction corresponds to a tire width direction.

### First Embodiment

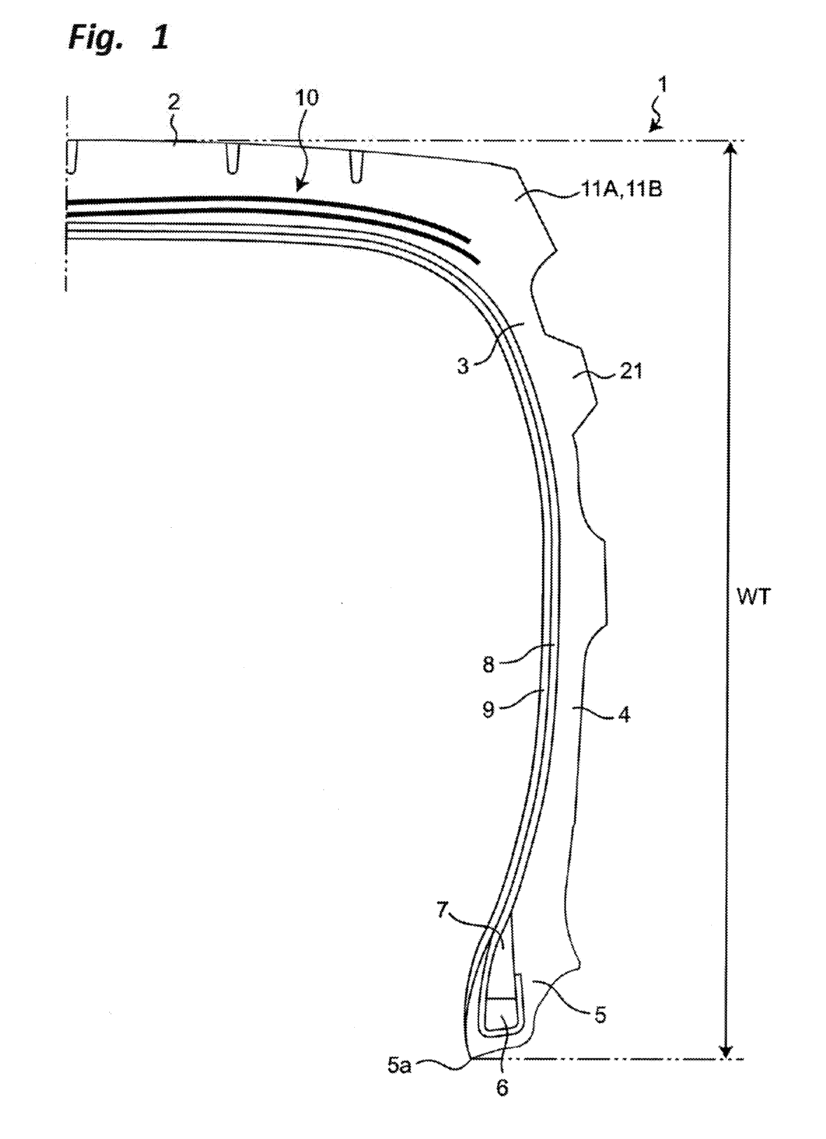

Referring to FIG. 1, a pneumatic tire 1 includes a tread portion 2, a pair of sidewall portions 4 extending from both ends of the tread portion 2 in the tire width direction toward the inside in the tire radial direction in the tire width direction via buttress portions 3 as transition regions, and a pair of bead portions 5 disposed at inner ends of the pair of sidewall portions 4 in the tire radial direction. Each of the bead portions 5 includes a bead core 6 having an annular shape, and a bead filler 7 disposed outside the bead core 6 in the tire radial direction.

A carcass plus 8 having a toroidal shape is disposed between the pair of bead portions 5 inside the tread portion 2 and the sidewall portions 4 in the tire radial direction. An inner liner 9 is disposed inside the carcass plus 8 in the tire radial direction. A belt layer 10 is provided in the tread portion 2 outside the carcass plus 8 in the tire radial direction.

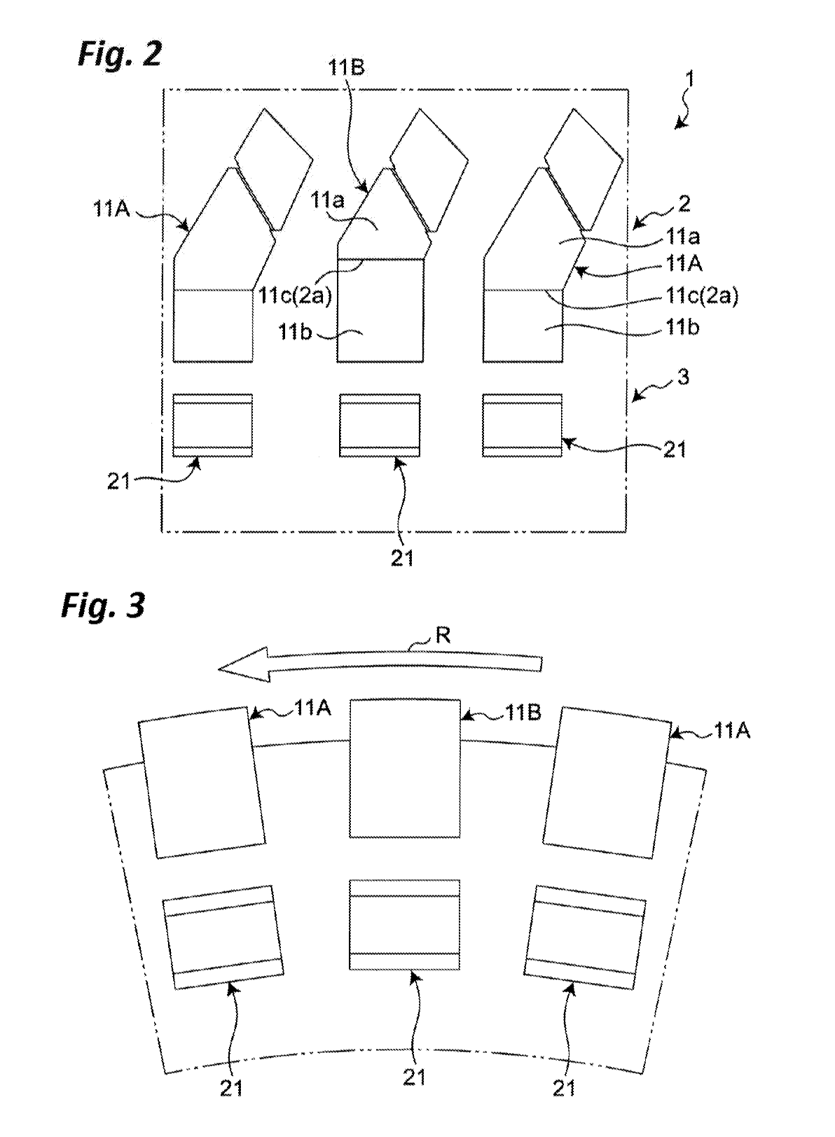

Referring to both FIGS. 2 and 3, blocks 11A and 11B provided in a region outside the tread portion 2 in the tire width direction extend from the tread portion 2 to the buttress portion 3. The blocks 11A and 11B are alternately arranged in the tire circumferential direction. Each of the blocks 11A and 11B includes a portion 11a extending in the tire width direction in the tread portion 2, and a portion 11b extending in the tire radial direction in the buttress portion 3. The respective portions 11a and 11b define an edge 11c. According to the present embodiment, the edge 11c constitutes a tread end 2a.

A position of the edge 11c of the block 11B in the tire width direction (second position) is located closer to the center in the tire width direction than a position of the edge 11c of the block 11A in the tire width direction (first position) is. Accordingly, the edge 11c of the block 11A and the edge 11c of the block portion 11B form repetitive steps in the tire circumferential direction (staggered shoulder structure).

Protrusions 21 protruding in the tire width direction are provided adjacent to the respective blocks 11A and 11B in the buttress portion 3. The position and size of each of the protrusions 21 are not limited to those specified in the present embodiment. More specifically, the position and the size of each of the protrusions 21 may be set such that each of an outer end and an inner end of the protrusion 21 in the tire radial direction is located at a height in a range not less than 0.1 and not more than 1.0 times a tire height WT from an innermost end 5a of the bead portion 5, which end is an inner most end of the pneumatic tire 1.

The protrusions 21 provided on the buttress portions 3 improve traction performance. Particularly according to the present embodiment, the protrusions 21 are provided adjacent to the blocks 11A and 11B where the edges 11c form repetitive steps in the tire circumferential direction as described above. Traction performance effectively improves by cooperative operation of the blocks 11A and 11B forming the steps, and the protrusions 21.

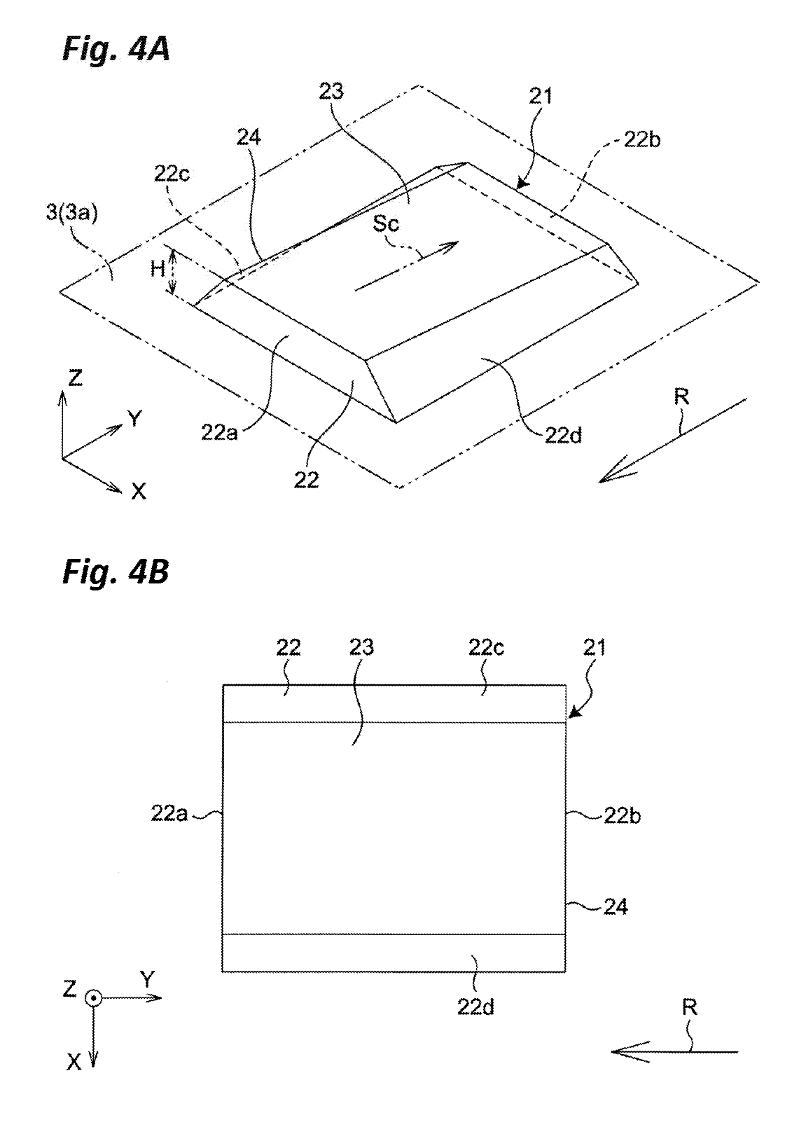

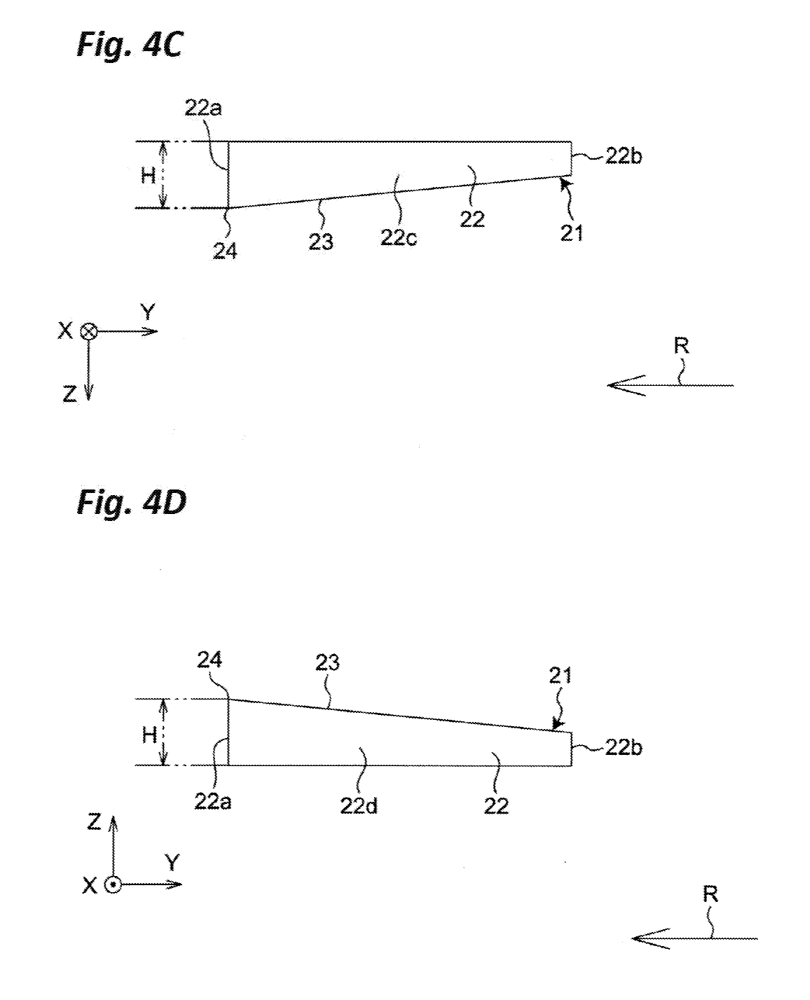

Referring to FIGS. 4A to 4D, the protrusion 21 includes a side wall 22 protruding in the tire width direction from a surface 3a of the buttress portion 3, and a top wall 23 provided at a distal end of the side wall 22. An edge 24 is defined by the side wall 22 and the top wall 23.

According to the present embodiment, the top wall 23 is a flat surface having a rectangular shape as viewed in the tire width direction. The top wall 23 is inclined in the tire circumferential direction such that a protrusion height H, which is a distance of the protrusion from the surface 3a of the buttress portion 3, decreases from one side to the other side in the tire circumferential direction. The direction of this inclination is conceptually indicated by an arrow Sc in FIG. 4A. According to the present embodiment, the top wall 23 has no inclination in the tire radial direction, and is parallel to the surface 3a of the buttress portion 3 in the tire radial direction. This point is applicable to a second embodiment described below.

The side wall 22 includes a pair of portions 22a and 22b facing each other in the tire width direction, a portion 22c constituting an outer end of the protrusion 21 in the tire radial direction, and a portion 22d constituting an inner end of the protrusion 21 in the tire radial direction.

Each of the pair of portions 22a and 22b facing each other in the tire circumferential direction is a flat surface which extends while crossing the surface 3a of the buttress portion 3 and the tire circumferential direction at right angles. In addition, according to the present embodiment, each of the portions 22a and 22b has an isosceles trapezoidal shape. The portions 22a and 22b have different areas. Specifically, the area of the portion 22b is smaller than the area of the portion 22a. More specifically, the bases of the isosceles trapezoidal shapes constituting the portions 22a and 22b have the same length (width). However, the height of the portion 22b is smaller than the height of the portion 22a.

As most clearly shown in FIGS. 4C and 4D, each of the portions 22c and 22d included in the side wall 21 and constituting the outer end or the inner end of the protrusion 21 in the tire radial direction is a trapezoidal flat surface. In addition, as most clearly shown in FIG. 4A, each of the portions 22c and 22d is an inclined surface.

According to knowledge of the present inventor, failure or external damage of the protrusion provided in the buttress portion is chiefly produced as a crack at a boundary between the side portion on the kicking side and the surface of the buttress portion. When the rotation direction of the pneumatic tire 1 is a direction indicated by an arrow R in the figure, the portion 22b, which is one of the pair of portions 22a and 22b included in the side wall 22 and facing each other in the tire circumferential direction, comes to the kicking side. In this case, the top wall 23 of the protrusion 21 is inclined in the tire circumferential direction such that the protrusion height H decreases from the portion 22a of the side wall 22 on the treading side in the tire circumferential direction toward the portion 22b of the side wall 22 on the kicking side. In this case, the portion 22b of the side wall 22 on the side having the smaller protrusion height H comes to the kicking side. Accordingly, movement of the protrusion 22 at the time of kicking decreases more than in a case where the portion 22a of the side wall 22 having the larger protrusion height comes to the kicking side. As a result, external damage resistance of the protrusion 21 improves.

According to the pneumatic tire 1 of the present embodiment as described above, external damage resistance of the protrusion 21 provided on the buttress portion 3 improves while securing traction performance.

Each of the pair of portions 22a and 22b facing each other in the tire width direction may have a shape other than an isosceles trapezoidal shape, such as a rectangular shape. This point is applicable to the second embodiment described below.

The second embodiment and a third embodiment of the present invention will be hereinafter described. Structures, actions, and functions not particularly mentioned in the following embodiments are similar to those of the first embodiment. In addition, elements identical or similar to the corresponding elements of the first embodiment are given identical reference numbers, and the description and figures relating to these elements of the first embodiment will be also referred to.

### Second Embodiment

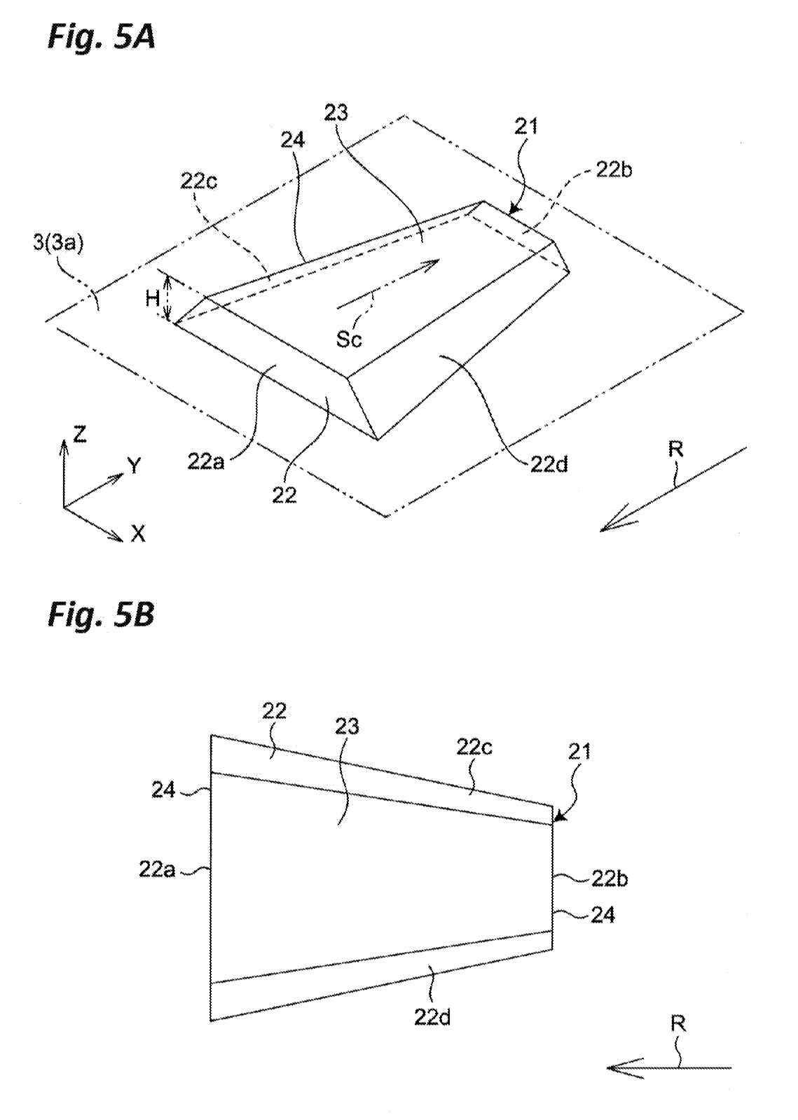

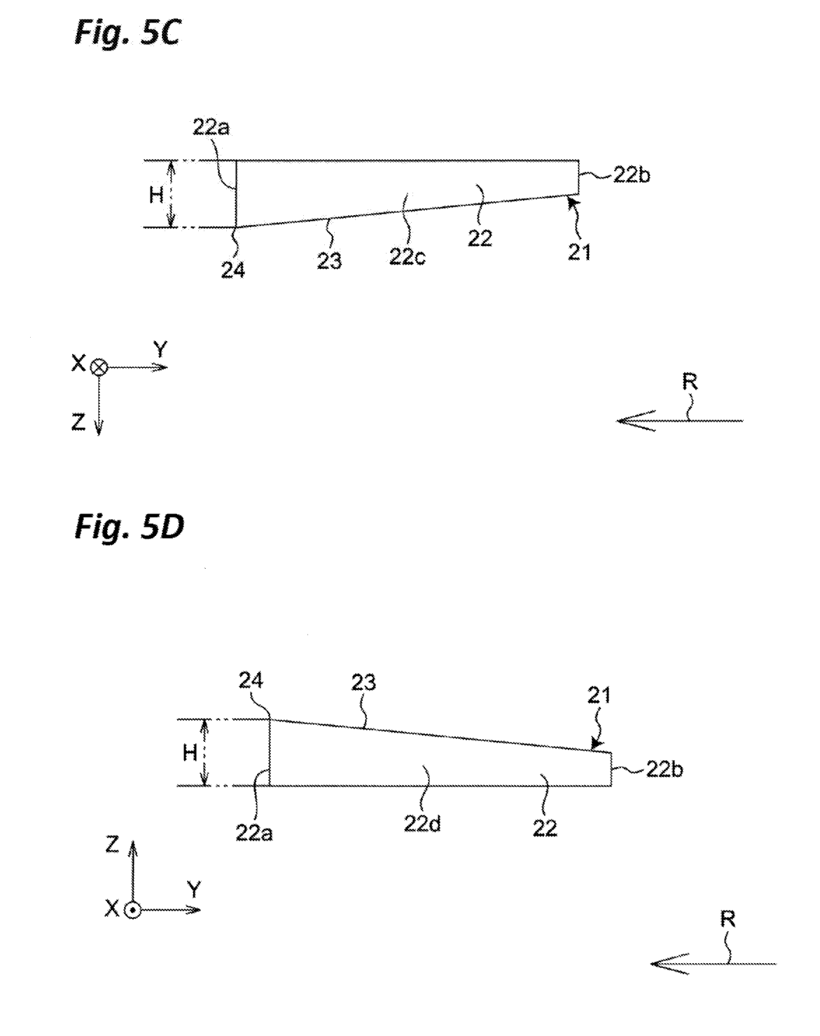

FIGS. 5A to 5D show the protrusion 21 according to a second embodiment of the present invention. According to the present embodiment, the pair of portions 22a and 22b included in the side wall 22 of the protrusion 21 and facing each other in the tire circumferential direction have different areas. Specifically, the area of the portion 22b is smaller than the area of the portion 22a. More specifically, the portions 22a and 22b have similar isosceles trapezoidal shapes. However, the portion 22b has smaller dimensions (height, length of oblique side, length of lower base, and length of upper base) than those of the portion 22a.

According to the present embodiment, the top wall 23 of the protrusion 21 has an isosceles trapezoidal shape as viewed in the tire width direction. Moreover, the side wall 23 of the protrusion 21 according to the present embodiment is inclined in the tire circumferential direction such that the protrusion height H decreases from the portion 22a of the side wall 22 toward the portion 22b (arrow Sc) similarly to the first embodiment. In the state that the top wall 23 is inclined in the tire circumferential direction in this manner, the portion 22b, which is one of the pair of portions 22a and 22b included in the side wall 22 and facing each other in the tire circumferential direction of the side wall 22, i.e., the side having the smaller protrusion height H, comes to the kicking side when the rotation direction of the pneumatic tire 1 is the direction indicated by the arrow R in the figure. Accordingly, movement of the protrusion 21 at the time of kicking decreases more than in a case where the side having the larger protrusion height, i.e., the portion 22a of the side wall 22, comes to the kicking side. As a result, external damage resistance of the protrusion 21 improves.

### Third Embodiment

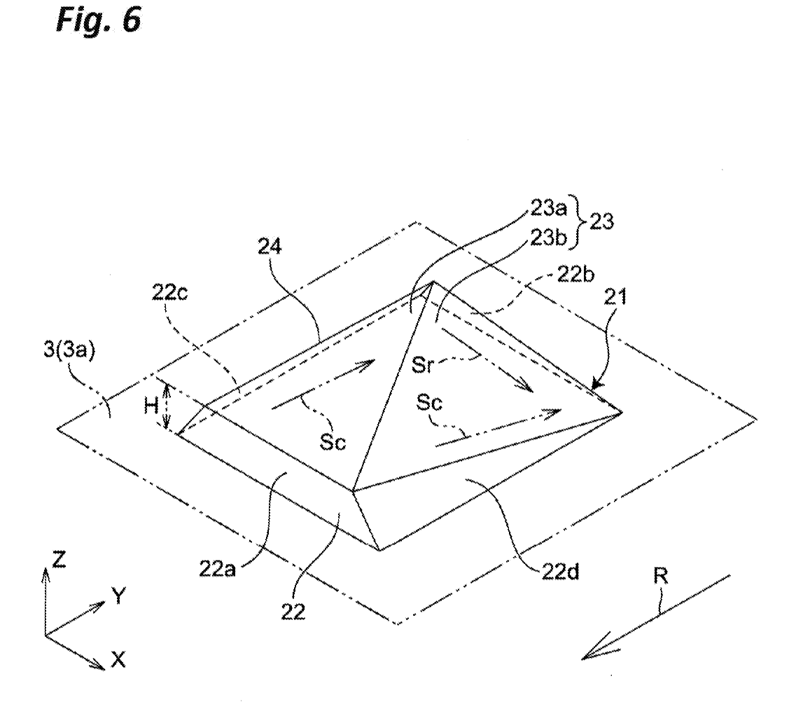

FIG. 6 shows the protrusion 21 in the third embodiment of the present invention. According to the present embodiment, the pair of portions 22a and 22b included in the side wall 22 of the protrusion 21 and facing each other in the tire circumferential direction have different areas. Specifically, the area of the portion 22b is smaller than the area of the portion 22a. More specifically, the portion 22a has an isosceles trapezoidal shape, while the portion 22b has a triangular shape. The base of the triangular shape of the portion 22b has the same length as the length of the lower base of the isosceles trapezoidal shape of the portion 22a. However, the height of the triangular shape of the portion 22b is smaller than the height of the isosceles trapezoid shape of the portion 22a.

The top wall 23 of the protrusion 21 according to the present embodiment has a portion 23a which constitutes a flat surface inclined only in the tire circumferential direction (arrow Sc), and a portion 23b which constitutes a flat surface inclined both in the tire circumferential direction (arrow Sc) and in the tire radial direction (arrow Sr).

When the rotation direction of the pneumatic tire 1 is the direction indicated by the arrow R in the figure, the portion 22b, which is one of the pair of portions 22a and 22b included in the side wall 22 and facing each other in the tire circumferential direction of the side wall 22, i.e., the side having the smaller protrusion height H, comes to the kicking side. Accordingly, movement of the protrusion 21 at the time of kicking decreases more than in a case where the side having the larger protrusion height, i.e., the portion 22a of the side wall 22, comes to the kicking side. As a result, external damage resistance of the protrusion 21 improves.

What is claimed is:

1. A pneumatic tire comprising a protrusion provided on a buttress portion, wherein
the protrusion includes
a side wall protruding from a surface of the buttress portion, and
a top wall provided at a distal end of the side wall, and
the top wall is inclined in a tire circumferential direction such that a protrusion height that is a distance of the protrusion from the surface of the buttress portion decreases from one side to the other side in the tire circumferential direction.

2. The pneumatic tire according to claim 1, wherein each of a pair of portions included in the side wall and facing each other in the tire circumferential direction has a quadrangular shape.

3. The pneumatic tire according to claim 2, wherein a quadrangular shape of one of the pair of portions included in the side wall and facing each other in the tire circumferential direction has a width equal to a width of a quadrangular shape of the other of the portions, and a height smaller than a height of the other of the portions.

4. The pneumatic tire according to claim 2, wherein the quadrangular shape of one of the pair of portions included in the side wall and facing each other in the tire circumferential direction is similar to the quadrangular shape of the other of the portions, and has a dimension smaller than a dimension of the quadrangular shape of the other of the portions.

5. The pneumatic tire according to claim 2, wherein the pair of portions included in the side wall and facing each other in the tire circumferential direction have different shapes.

6. The pneumatic tire according to claim 1, wherein each of an outer end and an inner end of the protrusion in a tire radial direction is disposed at a height in a range not less than 0.1 and not more than 1.0 times a tire height from an innermost end of the pneumatic tire.

7. The pneumatic tire according to claim 2, wherein each of an outer end and an inner end of the protrusion in the tire radial direction is disposed at a height in a range not less than 0.1 and not more than 1.0 times a tire height from an innermost end of the pneumatic tire.

8. The pneumatic tire according to claim 3, wherein each of an outer end and an inner end of the protrusion in the tire radial direction is disposed at a height in a range not less than 0.1 and not more than 1.0 times a tire height from an innermost end of the pneumatic tire.

9. The pneumatic tire according to claim 4, wherein each of an outer end and an inner end of the protrusion in the tire radial direction is disposed at a height in a range not less than 0.1 and not more than 1.0 times a tire height from an innermost end of the pneumatic tire.

10. The pneumatic tire according to claim 5, wherein each of an outer end and an inner end of the protrusion in the tire radial direction is disposed at a height in a range not less than 0.1 and not more than 1.0 times a tire height from an innermost end of the pneumatic tire.

11. The pneumatic tire according to claim 6, further comprising a block that extends from a tread portion to the buttress portion beyond a tread end,
wherein the protrusion is disposed such that an outer end of the protrusion is located adjacent to an inner end of the block in the tire radial direction.

12. The pneumatic tire according to claim 7, further comprising a block that extends from a tread portion to the buttress portion beyond a tread end,
wherein the protrusion is disposed such that an outer end of the protrusion is located adjacent to an inner end of the block in the tire radial direction.

13. The pneumatic tire according to claim 8, further comprising a block that extends from a tread portion to the buttress portion beyond a tread end,
wherein the protrusion is disposed such that an outer end of the protrusion is located adjacent to an inner end of the block in the tire radial direction.

14. The pneumatic tire according to claim 9, further comprising a block that extends from a tread portion to the buttress portion beyond a tread end,
wherein the protrusion is disposed such that an outer end of the protrusion is located adjacent to an inner end of the block in the tire radial direction.

15. The pneumatic tire according to claim 10, further comprising a block that extends from a tread portion to the buttress portion beyond a tread end,
wherein the protrusion is disposed such that an outer end of the protrusion is located adjacent to an inner end of the block in the tire radial direction.

16. The pneumatic tire according to claim 11, wherein
the block includes a first block having an edge that is defined by a portion extending in the tire width direction and a portion extending in the tire radial direction, and that is located at a first position,
the block includes a second block having an edge that is defined by a portion extending in the tire width direction and a portion extending in the tire radial direction, and that is located at a second position closer to a center in the tire width direction than the first position is, and
the first block and the second block are alternately arranged in the tire circumferential direction.

17. The pneumatic tire according to claim 12, wherein
the block includes a first block having an edge that is defined by a portion extending in the tire width direction and a portion extending in the tire radial direction, and is that located at a first position,
the block includes a second block having an edge that is defined by a portion extending in the tire width direction and a portion extending in the tire radial direction, and that is located at a second position closer to a center in the tire width direction than the first position is, and
the first block and the second block are alternately arranged in the tire circumferential direction.

18. The pneumatic tire according to claim 13, wherein
the block includes a first block having an edge that is defined by a portion extending in the tire width direction and a portion extending in the tire radial direction, and that is located at a first position,
the block includes a second block having an edge that is defined by a portion extending in the tire width direction and a portion extending in the tire radial direction, and that is located at a second position closer to a center in the tire width direction than the first position is, and
the first block and the second block are alternately arranged in the tire circumferential direction.

19. The pneumatic tire according to claim 14, wherein
the block includes a first block having an edge that is defined by a portion extending in the tire width direction and a portion extending in the tire radial direction, and is located at a first position,
the block includes a second block having an edge that is defined by a portion extending in the tire width direction and a portion extending in the tire radial direction, and is located at a second position closer to a center in the tire width direction than the first position is, and
the first block and the second block are alternately arranged in the tire circumferential direction.

20. The pneumatic tire according to claim 15, wherein
the block includes a first block having an edge that is defined by a portion extending in the tire width direction and a portion extending in the tire radial direction, and is located at a first position,
the block includes a second block having an edge that is defined by a portion extending in the tire width direction and a portion extending in the tire radial direction, and is located at a second position closer to a center in the tire width direction than the first position is, and
the first block and the second block are alternately arranged in the tire circumferential direction.
